(19) United States
(12) Patent Application Publication
(10) Pub. No.: US 2006/0081021 A1
(43) Pub. Date: Apr. 20, 2006

(54) Security device including linearly moving member

(75) Inventors: Ralph Merrem, San Francisco, CA (US); Phil Smith, Monterey Park, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands, Inc., Lincolnshire, IL (US)

(21) Appl. No.: 10/970,060

(22) Filed: Oct. 20, 2004

(51) Int. Cl. E05B 73/00

(52) U.S. Cl. 70/58

(57) ABSTRACT

A security device is disclosed. The security device includes a casing including a front opening. A securing member is coupled to the casing. A movable locking member extends outward when the security device is in a locked configuration and is retracted inward when the security device is in an unlocked configuration. A locking mechanism in the security device can keep the movable locking member in the locked configuration. A button passing through the casing can be depressed or otherwise moved to cause the movable locking member to retract, to thereby put the security device in an unlocked configuration.

### CROSS-REFERENCES TO RELATED APPLICATIONS

Not Applicable

### BACKGROUND OF THE INVENTION

It is desirable to secure articles such as portable computers. This is usually accomplished using a lock that has a wire cable looped through something immovable.

FIG. 7 shows a conventional lock that can be used to secure an article. The lock has a main body 350 having a plurality of dials 351 and a socket 352 for detachably receiving a separate hitching part 360. Before or after a front hook of the hitching part 360 passes through a port in an article, the dials 351 need to be turned to a preset combination to allow the rear disk-like end of the hitching part 360 to be placed into the socket 352 and fixedly attached to the main body 350.

The lock is opened by turning the dials 351 to the preset combination again before moving a slider 353 of the main body 350. At this time, the hitching part 360 can be detached from the main body 350.

The lock shown in FIG. 7 has some disadvantages. For example, the separate hitching part 360 of the conventional lock can get lost and the remaining main body 350 then becomes useless.

Embodiments of the invention address this problem and other problems, individually and collectively.

### SUMMARY OF THE INVENTION

Embodiments of the invention are directed to security devices and methods for using security devices.

One embodiment of the invention is directed to a security device comprising: a casing comprising a front opening; a securing member coupled to the casing; a movable locking member that is extended outward if the security device is in a locked configuration and is retracted inward when the security device is in an unlocked configuration; a button for causing the movable locking member to retract; and a locking mechanism coupled to the button.

Another embodiment of the invention is directed to a method comprising: obtaining a security device comprising a casing comprising a front opening, a securing member coupled to the casing, a movable locking member, a rod coupled to the movable locking member, and a button extending out of the casing; pushing the rod to extend the movable locking member outward; securing the security device to an article; and unlocking the security device by pushing the button.

Another embodiment of the invention is directed to a security device comprising: a casing comprising a front opening, wherein the casing is oriented according to a first direction; an L-shaped securing member coupled to the casing; a movable bolt including a lip that is extended outward when the security device is in a locked configuration and is retracted inward when the security device is in an unlocked configuration; a button for causing the movable locking member to retract, wherein the button is pushed in a second direction perpendicular to the first direction; and a combination locking mechanism for keeping the movable locking member in the locked configuration.

These and other embodiments of the invention will be described in further detail below.

### BRIEF DESCRIPTION OF THE DRAWINGS

FIG. 1 shows an exploded front perspective view of a security device according to an embodiment of the invention.

FIG. 2 shows an exploded bottom perspective view of the security device shown in FIG. 1.

FIG. 3 shows an exploded rear top perspective view of the security device shown in FIGS. 1 and 2.

FIG. 4 shows a front view of a security device.

FIG. 5 shows a side cross-sectional view of a security device according to an embodiment of the invention.

FIG. 6 shows a perspective view of a security device according to an embodiment of the invention.

FIG. 7 shows a prior art lock.

In the foregoing Figures, it is understood that like numerals designate like elements. It is also understood that descriptive terms such as “rearward”, and “forward” are used relative to the examples shown in the Figures, and may or may not refer to absolute direction or positions.

### DETAILED DESCRIPTION

One embodiment of the invention is directed to a security device comprising a casing comprising a front opening. A securing member is coupled to the casing. The securing member is for securing the security device to an article that is to be immobilized. A movable locking member in the security device can extend outward from the casing when the security device is in a locked configuration and can retract inward when the security device is in an unlocked configuration. A locking mechanism in the security device keeps the movable locking member in the locked configuration. The locking mechanism preferably comprises a combination lock, but could comprise a key lock in other embodiments. A button passing through the casing can be depressed to cause the movable locking member to retract so that the security device is in an unlocked configuration. This and other embodiments of the invention are described with reference to the Figures.

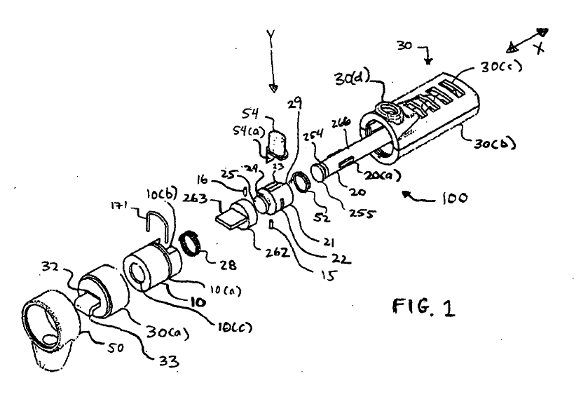

FIG. 1 shows an exploded front perspective view of a security device 100 according to an embodiment of the invention. As shown, the security device 100 in this example is somewhat longitudinally oriented along the axis X.

The security device 100 includes a casing 30 formed from a first casing portion 30(a) and a second casing portion 30(b). Although two casing portions 30(a), 30(b) are shown in this example, any number of casing portions may be provided in other examples. The casing 30 can be made of steel, a zinc die cast material, or any other suitable material.

Any suitable retention structure may be used in conjunction with the casing 30 in the security device 100. For example, the casing 30 can pass through and interface with a cable anchor 50 which may rotate around a portion of the casing 30. The cable anchor 50 may have a cable (not shown) attached to it. The cable may be used to wrap around an immovable object such as a desk. In other embodiments, the cable may alternatively be a chain, U-shaped bar, or other retention structure.

As shown in FIG. 1, the first casing portion 30(a) has a securing member 33 in the form of an L-leg coupled to it. An aperture 32, which is adapted to receive a movable lip 263 (or other locking member), is positioned above the securing member 33. As shown, the lip 263 has a flat shape, and a rectangular cross section. Although a movable lip is shown as being an example of a locking member, it is understood that the locking member may take other forms in other embodiments of the invention. For example, a locking member could comprise one or more elongated pins that are inserted into a security slot.

The securing member 33 may be directly or indirectly coupled to the first casing portion 33, with or without intervening structures. For example, the securing member 33 may be coupled to the first casing portion 30(a) using any suitable attachment mechanism including a pin, bolt, weld, adhesive, etc. The securing member 33 may also be integrally formed with the first casing portion 30(a).

The securing member 33 may have any suitable dimensions and shape. In some embodiments, the securing member 33 may be configured so that it can fit within a security slot in a standard computer so that it engages the security slot. For example, the securing member 33 may have at least one cross-sectional dimension that is less than about 7 mm by about 3 mm so that it can fit through a security slot in a computer. In other embodiments, the securing member 33 could take the form of a T-bar that can be inserted into a security slot. The T-bar can then be turned to a locked configuration so that a portion of the security slot is unfilled. A linearly moving locking member such as a pin or a bolt may then fill a remaining portion of the security slot. These and other types of securing members are described in U.S. Pat. Nos. 6,591,642, 6,000,557, and 6,000,252, which are herein incorporated by reference in their entirety for all purposes.

The second casing portion 30(b) includes a number of apertures 30(c). The apertures 30(c) may serve as windows for displaying the numbers on dials (not shown) that are received in the apertures 30(c). The displayed dials may form a combination for a combination lock mechanism (not shown) that is present in the security device 100. The second casing portion 30(b) also includes a hole 30(d) for a push button 54.

A number of other components are at least partially inside of the casing 30. For example, a cylinder 20 (or more generally a rod) is at least partially inside of the casing 30. The cylinder 20 is capable of moving along the axis X when the security device 100 is in an unlocked configuration. A disk portion 255 and a recess 254 are at a forward end of the cylinder 20. The cylinder 20 also includes two anti-rotation structures 20(a) inside of the casing 30. The anti-rotation structures 20(a) can fit into tracks (not shown) formed in the first casing portion 30(a) to prevent the cylinder 20 from rotating. In this example, the anti-rotation structures may be linear protrusions that are aligned with the axis X.

The main portion 266 of the cylinder 20 may include notches or protrusions (not shown) that interface with the dials of a combination lock mechanism (not shown). Combination lock mechanisms are well known and one exemplary combination lock mechanism is described in U.S. Pat. No. 6,058,744, which is herein incorporated by reference in its entirety for all purposes. When the appropriate combination of dials is displayed through the apertures 30(c), the cylinder 20 is free to move along the longitudinal axis X. Although a combination lock is specifically suitable for the embodiment shown in FIG. 1, it is understood that embodiments of the invention are not limited to the use of combination locks. Key locking mechanisms can be used and are well known in the art.

The cylinder 20 is coupled to a rear portion of the stem 21 using a torsion element 52 and a pin 15. Together, the cylinder 20 and the stem 21 could form a cylindrical body. The pin 15 passes through the stem 21 and into a recess 254 between the disk portion 255 of the cylinder 20 and a main portion 266 of the cylinder 20. The pin 15 allows the stem 21 to rotate relative to the cylinder 20. The torsion element 52 biases the stem 21 to rotate clockwise, and this in turn biases the button 54 to extend upward in the absence of pressure on the button 54. In this example, the torsion element 52 is a torsion spring.

A bolt 262 including a lip 263 (or other securing member) is coupled to a forward portion of the stem 21 using a pin 16. The pin 16 passes though the bolt 262 and into a recess 24 formed between a disk portion 25 of the stem 21 and a main portion 29 of the stem 21. By coupling the stem 21 to the bolt 262 with the pin 16, the stem 21 can rotate relative to the bolt 262. When the security device 100 is in a locked configuration, the bolt 262 may extend through the aperture 32 in the first casing portion 30(a).

A push button 54 passes through the hole 30(d) in the top portion of the casing 30. An engaging portion 54(a) of the button 54 engages a recess 23 in the stem 21. When the button 54 is pushed down, the stem 21 rotates counterclockwise. This releases a retaining structure 171 such as a pair of shanks from another recess 22 in the stem 21. The recess 22 in the stem may be cooperatively structured with the retaining structure 171. This allows the stem 22, the bolt 262, and the cylinder 20 to move along the axis X. As shown in FIG. 1, the push button 54 can be pushed down in a direction Y, which is perpendicular to the axis X.

A hollow body 10 is at the front end of the security device 100. The hollow body 10 includes a receiving region 10(a) for receiving the retaining structure 171, a recess 10(b) for receiving at least a portion of the button 54, and a front aperture 10(c). The lip 263 passes through the front aperture 10(c) in the hollow body 10 and also the front aperture 32 in the first casing portion 30(a). Here, the lip 263 is in the form of a flat structure. In other embodiments, the lip 263 could alternatively be a pin or other structure that moves in a linear manner alongside the securing member 33.

A biasing structure 28 such as a spring is disposed around the lip 263 of the bolt 262. The biasing structure 28 biases the bolt 262 to move toward the rear of the security device 100 if the dials of the combination lock are set to the correct combination and if the retaining structure 171 is not disposed in the recess 22 in the stem 21. In this example, the biasing structure 28 is a spring. In other embodiments, the biasing structure 28 could be an elastomeric material (e.g., a rubber disk) or other material.

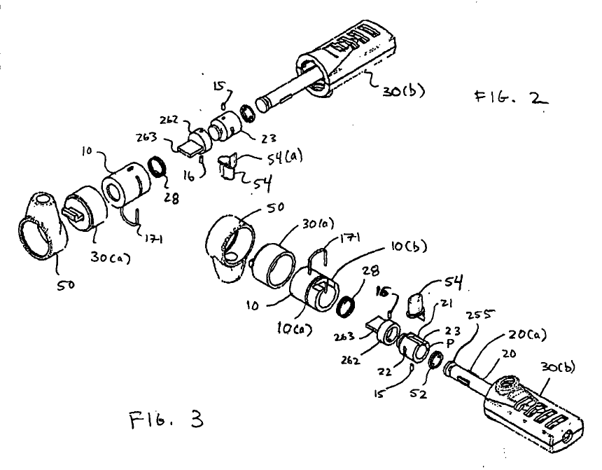

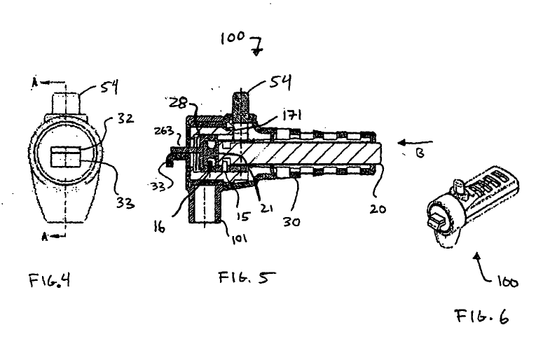

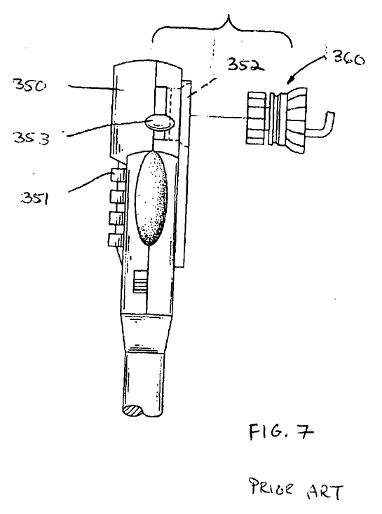

FIG. 2 shows an exploded bottom perspective view of the security device shown in FIG. 1. In FIG. 2, the configuration of the button 54 and its engaging portion 54(a), and the underside of the casing portion 30(b) are more clearly visible. The dials (not shown) of a combination lock may thus be seen on both sides of the casing 30 in this example, In other embodiments, the dials of a combination lock mechanism may be seen on only one side of the casing 30.

FIG. 3 shows an exploded rear bottom perspective view of the security device 100 shown in FIGS. 1 and 2. In FIG. 3, a point P is shown in the stem 21. One end of the torsion element 52 can be attached to the point P, while the other end of the torsion element 52 can be connected to a fixed point on the cylinder 20. The torsion element 52 rotationally biases the stem 21 relative to the cylinder 20.

FIG. 4 shows a front view of the security device when it is assembled together. As shown, the locking member 32 is disposed above the securing member 33. When the security device 100 is in a locked configuration, the locking member 263 and the securing member 33 are in a side-by-side relationship and can fill a security slot in a portable device such as a portable computer. The security slot may have dimensions of about 3 mm by about 7 mm and may be rectangularly shaped.

FIG. 5 shows a cross-sectional view of the security device along the line A-A in FIG. 4. As shown in FIG. 4, a user can push the rear end of the cylinder 20 in a direction B. This in turn pushes the stem 21, the bolt 262, and its corresponding lip 263 forward. The lip 263 then extends outward against the upper portion of the securing member 33. This can occur when the lock dials (not shown) that would be disposed around the cylinder 20 are set to the correct combination, thereby allowing for the linear movement of the cylinder 20 in the casing 30. When the combination of the dials is incorrect, the dials will restrict the linear movement of the cylinder 20 thus allowing the security device to remain in a locked configuration.

FIG. 5 also shows a structure 101 for receiving a cable coupled to the casing 30. The cable could alternatively be a chain, or other retaining structure.

FIG. 6 shows a perspective view of the security device when it is assembled.

A more detailed description of the operation of the security device can be provided. In one embodiment of the invention, a security device comprising a casing comprising a front opening, a securing member coupled to the casing, a movable locking member, a rod coupled to the movable locking member, and a button extending out of the casing is obtained.

To secure the security device to an article, the securing member is placed in a security slot in the article to thereby engage the securing member with the security slot. Once the securing member is engaged with the security slot, the user may push the rear end of the rod (e.g., a cylinder) forward to cause the movable locking member to extend outward alongside the securing member. The combination of a combination lock mechanism is then set to the incorrect combination. The security device is thereafter in a locked configuration.

To unlock the security device, the user may then dial the correct combination. Then, the button in the security device may be pushed. After pushing the button, the locking member and the rod retract rearwardly. This “unfills” the security slot in the article thereby allowing the securing member to be removed from the security slot.

The above-described locking method can be more clearly described with reference to FIGS. 1 and 5. To put the security device 100 into a locked configuration, a user could set the dials (not shown) of the combination lock in the security device 100 to the correct combination. Then, the user would place the securing member 33 into a security slot (not shown) in an article so that the securing member 33 partially fills and engages the security slot. After this, the user would push the rear end of the cylinder 20 toward the front of the security device in the direction shown by arrow B in FIG. 5. This in turn pushes the stem 21, and the bolt 262 forward. The lip 263 of the bolt 262 extends out of the aperture 10(c) in the hollow body 10 and also the aperture 32 in the casing 30 thus filling the security slot and inhibiting the securing member 33 from being withdrawn from the security slot. The retaining structure 171 then snaps into the recess 22 in the stem 21. The combination in the combination lock can then be changed to maintain the security device in a locked configuration. When the combination of the combination lock is not set at the correct combination, the dials (not shown) disposed around the cylinder 20 will keep the cylinder 20 from moving to the rear of the security device and will also keep the lip 263 extended outward alongside of the securing member 33.

To unlock the security device 100, the user can turn the dials disposed around the cylinder 20 so that the correct combination is displayed through the apertures 30(c) of the casing 30. Then, the user can press the button 54 down. This causes the stem 21 to rotate counterclockwise, thus causing the retaining structure 171 to be displaced out of the groove 22. Once the stem 21 and the retaining structure 171 are disengaged, the biasing structure 28 pushes the bolt 262, the stem 21, and the cylinder 20 backward toward the rear of the casing 30. As the bolt 262 moves toward the rear of the casing 30, the lip 262 is withdrawn back into the casing 30 and “unfills” the security slot. This changes the security device 100 from a locked configuration to an unlocked configuration. The securing member 33 can then be removed from the security slot.

The security devices according to embodiments of the invention can be used to localize any suitable portable article to an immovable object. Examples of articles that can be localized using the security device according to embodiments of the invention include computers (laptop computers), televisions (HDTV displays), flat panel displays, computer equipment such as routers, bicycles, wireless phones, etc.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None of them, and none of the descriptions in this application are admitted to be prior art.

1. A security device comprising:
a casing comprising a front opening and having a longitudinal direction;
a securing member coupled to the casing;
a movable locking member that is extended outward alone the longitudinal direction if the security device is in a locked configuration and is retracted inward along the longitudinal direction when the security device is in an unlocked configuration;
a button for causing the movable locking member to retract along the longitudinal direction; and
a locking mechanism coupled to the button.

2. The security device of claim 1 wherein the locking mechanism is a combination locking mechanism.

3. The security device of claim 1 wherein the locking mechanism is a key locking mechanism.

4. The security device of claim 1 wherein the security device further comprises a rod that is linearly movable inside of the casing when the locking mechanism is in an unlocked position.

5. The security device of claim 1 wherein the movable locking member includes a bolt including a lip, wherein the lip extends out of the casing when the movable locking member is in the locked configuration.

6. The security device of claim 1 further comprising a retaining structure and a stem, wherein the stem and the retaining structure are configured to be engaged to keep the movable locking member in a locked configuration.

7. The security device of claim 1 further comprising a stem, wherein the stem and the button are cooperatively configured so that depression of the button turns the stem.

8. The security device of claim 1 further comprising a hollow body disposed within the casing.

9. The security device of claim 1 further comprising a cylinder, a stem, and a torsion spring coupling the cylinder and the stem.

10. The security device of claim 1 further comprising a cylinder, wherein the cylinder extends outward from a rear portion of the casing.

11. The security device of claim 1 further comprising a stem, and a cylinder, and wherein the movable locking member and the stem are rotatably coupled together and wherein the cylinder and the stem are rotatably coupled together.

12. The security device of claim 1 wherein the casing has a longitudinal direction and wherein the button actuates in a direction perpendicular to the longitudinal direction.

13. A method comprising:
obtaining a security device comprising a casing comprising a front opening and having a longitudinal direction, a securing member coupled to the casing, a movable locking member, a rod coupled to the movable locking member, and a button extending out of the casing;
pushing the rod to extend the movable locking member outward alone the longitudinal direction;
securing the security device to an article; and
unlocking the security device by pushing the button.

14. The method of claim 13 wherein the article is a computer.

15. The method of claim 13 wherein the security device further comprises a combination locking mechanism including a plurality of dials, wherein the method further includes:
moving the dials to a correct combination, and then pushing the button.

16. The method of claim 13 wherein the securing member is in the form of an L-leg.

17. The method of claim 13 wherein the casing has an orientation and wherein the button is pushed in a direction perpendicular to the orientation of the casing.

18. The method of claim 13 wherein the security device includes a key locking mechanism.

19. The method of claim 13 wherein the securing member is an L-leg and wherein the locking member is a linear lip.

20. A security device comprising:
a casing comprising a front opening, wherein the casing is oriented according to a first direction;
an L-shaped securing member coupled to the casing;
a movable bolt including a lip that is extended outward along the first direction when the security device is in a locked configuration and is retracted inward alone the first direction when the security device is in an unlocked configuration;
a button for causing the movable bolt to retract along the first direction, wherein the button is pushed in a second direction perpendicular to the first direction; and
a combination locking mechanism for keeping the movable locking member in the locked configuration.

21. A security device for use with a slot in an article comprising:
a casing comprising a front opening;
a securing member coupled to the casing;
a movable locking member that is extended outward through the slot if the security device is in a locked configuration and is retracted inward and is not in the slot when the security device is in an unlocked configuration;
a button for causing the movable locking member to retract; and
a locking mechanism coupled to the button.
